(19) United States
(12) Patent Application Publication
(10) Pub. No.: US 2026/0187741 A1
(43) Pub. Date: Jul. 2, 2026

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventors: Kuniaki JINNAI, Yokohama-shi, (JP); Yorichika ISHIYAMA, Nagoya-shi, (JP); Yuhang ZHANG, Nagoya-shi, (JP)

(73) Assignee: TOYOTA JIDOSHA KABUSHIKI KAISHA, Toyota-shi (JP)

(21) Appl. No.: 19/381,098

(22) Filed: Nov. 6, 2025

(30) Foreign Application Priority Data
Dec. 26, 2024 (JP) 2024-231078

(51) Int. Cl. G06Q 50/18; G06F 40/30

(52) U.S. Cl. CPC G06Q 50/184; G06F 40/30

(57) ABSTRACT

There is provided an information processing device that includes a generation unit configured to generate an instruction text for instructing a generative model and a presentation unit configured to present an output from the generative model. The generation unit is configured to generate a first instruction text for instructing a generative model to extract a portion where a technical feature is unidentifiable in a text related to a scope of a patent right, and generate a second instruction text for instructing the generative model to extract a correspondence relationship with a technical document relevant to the text related to the scope of the patent right with respect to the portion extracted by the generative model, based on the first instruction text. The presentation unit is configured to present the correspondence relationship extracted by the generative model based on the second instruction text.

### CROSS-REFERENCE TO RELATED APPLICATION

This application claims priority to Japanese Patent Application No. 2024-231078 filed on Dec. 26, 2024. The disclosure of the above-identified application, including the specification, drawings, and claims, is incorporated by reference herein in its entirety.

### BACKGROUND

### 1. Technical Field

The present disclosure relates to an information processing device, an information processing method, and a storage medium.

### 2. Description of Related Art

There is a technique for supporting in understanding a patent document. Japanese Unexamined Patent Application Publication No. 2011-96200 (JP 2011-96200 A) discloses a technique that aims to enable focused reading of explanations of components that serve as key points in each claim in the claim section of the patent document by identifying and presenting the components.

### SUMMARY

A case is considered in which a generative artificial intelligence (AI) understands the description of each claim in the claim section, and to extract which part of another technical document corresponds to the content of each claim. The description of each claim in the claim section does not necessarily directly reflect expressions in the detailed description of the disclosure, and in some cases, the claims are abstractly described using expressions such as “a first something” and “a second something”. The descriptions of the claims that do not directly reflect the expressions of the detailed description of the disclosure may hinder a generative AI from understanding the contents described in the claims and may also lead to a misunderstanding of the contents described in the claims.

The present disclosure has been made in view of the above, and an object of the present disclosure is to provide an information processing device, an information processing method, and a storage medium that enable a generative AI to accurately understand the contents described in the claims, even when each claim in the claim section is described in an abstract manner.

An information processing device according to a first aspect of the present disclosure includes: a generation unit configured to generate an instruction text for instructing a generative model; and a presentation unit configured to present an output from the generative model. The generation unit is configured to generate a first instruction text for instructing the generative model to extract a portion where a technical feature is unidentifiable in a text related to a scope of a patent right, and generate a second instruction text for instructing the generative model to extract a correspondence relationship between the text related to the scope of the patent right and a technical document relevant to the text related to the scope of the patent right, with respect to the portion extracted by the generative model based on the first instruction text. The presentation unit is configured to present the correspondence relationship extracted by the generative model based on the second instruction text.

An information processing device according to a second aspect of the present disclosure is the information processing device according to the first aspect, in which the technical document is a specification of an application in which the text related to the scope of the patent right is described or a standard document relevant to the text related the scope of the patent right.

An information processing device according to a third aspect of the present disclosure is the information processing device according to the first aspect, in which the text related to the scope of the patent right is a text in a claim section of a patent document.

An information processing method according to a fourth aspect of the present disclosure includes: executing by a processor: generating a first instruction text for instructing a generative model to extract a portion where a technical feature is unidentifiable in a text related to a scope of a patent right; generating a second instruction text for instructing the generative model to extract a correspondence relationship between the text related to the scope of the patent right and a technical document relevant to the text related to the scope of the patent right, with respect to the portion extracted by the generative model based on the first instruction text; and presenting the correspondence relationship extracted by the generative model, based on the second instruction text.

An information processing program stored in a storage medium according to a fifth aspect of the present disclosure causes a computer to execute: generating a first instruction text for instructing a generative model to extract a portion where a technical feature is unidentifiable in a text related to a scope of a patent right; generating a second instruction text for instructing the generative model to extract a correspondence relationship between the text related to the scope of the patent right and a technical document relevant to the text related to the scope of the patent right, with respect to the portion extracted by the generative model based on the first instruction text; and presenting the correspondence relationship extracted by the generative model, based on the second instruction text.

According to the present disclosure, it is possible to provide an information processing device, an information processing method, and a storage medium that enable a generative AI to accurately understand the contents of the descriptions of claims, even when each claim in the claim section is described in an abstract manner.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an outline of an information processing device according to an embodiment of the disclosure;

FIG. 2 is a block diagram showing a hardware configuration of the information processing device;

FIG. 3 is a block diagram showing an example of a functional configuration of the information processing device;

FIG. 4 is a diagram showing an example of GUI presentation on a display unit by a presentation unit;

FIG. 5 is a diagram showing an example of GUI presentation on a display unit by a presentation unit; and

FIG. 6 is a flowchart showing a flow of information processing by the information processing device.

### DETAILED DESCRIPTION OF EMBODIMENTS

Hereinafter, an example of an embodiment of the present disclosure will be

described with reference to the drawings. In addition, the identical or equivalent components and portions in each drawing are denoted by the same reference numerals. Further, the dimensional ratios in the drawings are exaggerated for convenience of explanation, and may differ from the actual ratios.

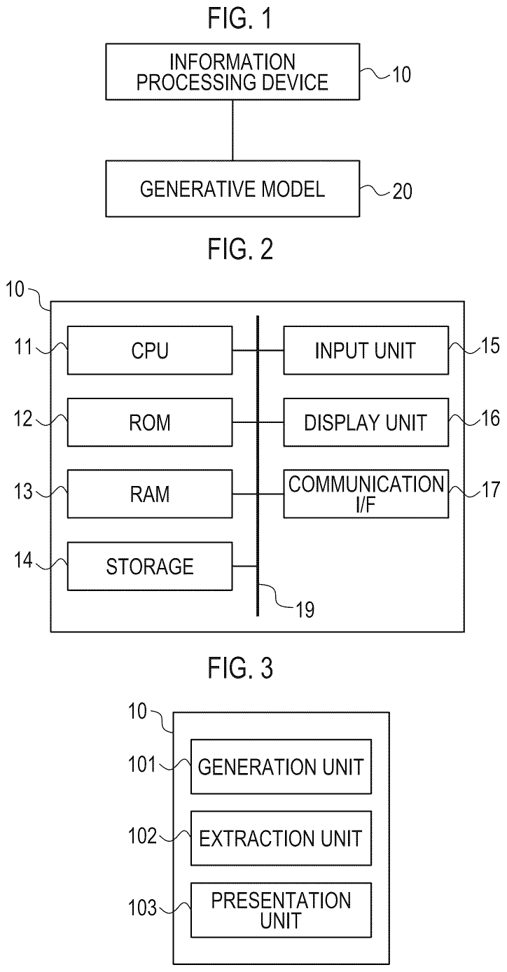

FIG. 1 is a diagram showing an outline of an information processing device according to the present embodiment. The information processing device 10 according to the present embodiment is a device for supporting the understanding of a patent document. The patent document refers to a document related to a patent, such as a published unexamined patent application or a patent bulletin. The patent document generally includes claims, a detailed description of the disclosure, an abstract, and drawings. The information processing device 10 is a device that causes the generative model 20 to read the patent document and the technical document to be compared with the patent document, provides a predetermined instruction text (prompt) to the generative model 20, and causes the generative model 20 to output the descriptions of the claims of the patent document and the correspondence relationship with the technical document. Here, the technical document includes a patent document, a technical specification, a technical standard, a product manual, a product brochure, and the like.

The generative model 20 is a trained model that has been machine-learned in advance to generate and output a text, an image, or the like in response to an input. For example, the generative model 20 may use a model that generates the text in response to the input, such as a GPT series (for example, GPT-3, GPT-4), BERT, or RoBERTa.

The generative model 20 may be stored in a device different from the information processing device 10 or may be stored in the same device as the information processing device 10.

FIG. 2 is a block diagram showing a hardware configuration of the information processing device 10.

As shown in FIG. 2, the information processing device 10 includes a central processing unit (CPU) 11, a read only memory (ROM) 12, a random access memory (RAM) 13, a storage 14, an input unit 15, a display unit 16, and a communication interface (I/F) 17. The respective configurations are communicably connected to each other via a bus 19.

The CPU 11 is a central processing unit that executes various programs or controls each unit. That is, the CPU 11 reads a program from the ROM 12 or the storage 14 and executes the program using the RAM 13 as a work area. The CPU 11 performs control of the respective configurations and various arithmetic processes according to a program recorded in the ROM 12 or the storage 14. In the present embodiment, the ROM 12 or the storage 14 stores an information processing program that causes the generative model 20 to understand the contents of the claims of the patent document. The ROM 12 or the storage 14 is an example of a storage medium.

The ROM 12 stores various programs and various data. The RAM 13 temporarily stores a program or data as a work area. The storage 14 is configured by a storage device, such as a hard disk drive (HDD), a solid state drive (SSD), or a flash memory, and stores various programs including an operating system, and various data.

The input unit 15 includes a pointing device, such as a mouse, and a keyboard, and is used to perform various inputs.

The display unit 16 is, for example, a liquid crystal display, and displays various kinds of information. The display unit 16 may adopt a touch panel method and function as an input unit 15.

The communication interface 17 is an interface for communicating with other devices, and a standard such as Ethernet (registered trademark), FDDI, or Wi-Fi (registered trademark) is used.

When the information processing program is executed, the information processing device 10 uses the hardware resources to implement various functions. A functional configuration implemented by the information processing device 10 will be described.

FIG. 3 is a block diagram showing an example of a functional configuration of the information processing device 10.

As shown in FIG. 3, the information processing device 10 includes a generation unit 101, an extraction unit 102, and a presentation unit 103 as a functional configuration. Each functional configuration is implemented by the CPU 11 reading and executing the information processing program stored in the ROM 12 or the storage 14.

The generation unit 101 generates an instruction text (prompt) for the generative model 20. The generation unit 101 starts the generation of the instruction text, for example, in response to an instruction of the user of the information processing device 10. Specifically, the generation unit 101 generates an instruction text for instructing the generative model 20 to extract a portion where the technical feature is unidentifiable in the claims of the patent document. The claims of the patent document are an example of a text related to the scope of rights of the patent of the present disclosure. An instruction text for instructing the generative model 20 to extract a portion where the technical feature is unidentifiable in the claims of the patent document is an example of the first instruction text of the present disclosure.

For example, the generation unit 101 generates an instruction text such as “Please extract a portion where the technical feature is unidentifiable in the following text in the claims”. The instruction text may also be a text such as “Please extract an undefined portion”, or “Please extract a portion that is not interpreted in the claims”. The generation unit 101 may further add a specific description to the instruction text. For example, the generation unit 101 may include, in the instruction text, a description of what kind of portion constitutes a portion where the technical feature is unidentifiable. An example of a portion where the technical feature is unidentifiable is a specific item with an ordinal number, such as “first” or “second”.

The generation unit 101 generates an instruction text for instructing the generative model 20 to extract the correspondence relationship between the claims and the technical document relevant to the claims with respect to the portion where the technical feature is unidentifiable in the claims of the patent document, the portion having been extracted by the generative model 20. An instruction text for instructing the generative model 20 to extract the correspondence relationship between the claims and the technical document relevant to the claims is an example of a second instruction text of the present disclosure.

For example, the generation unit 101 generates an instruction text such as, “Please read the technical document relevant to the claims and extract, from the entire text of the technical document, the configuration in the technical document corresponding to the following configuration in the claims”.

The extraction unit 102 provides the instruction text generated by the generation unit 101 to the generative model 20 to acquire the text generated by the generative model 20. More specifically, the extraction unit 102 extracts a portion where the technical feature is unidentifiable in the claims of the patent document by providing the generative model 20 with an instruction text for instructing the extraction of a portion where the technical feature is unidentifiable in the claims of the patent document, and acquiring a text generated by the generative model 20. The extraction unit 102 may also extract a correspondence relationship between the claims and a technical document relevant to the claims by providing the generative model 20 with an instruction text for instructing the generative model 20 to extract the correspondence relationship between the claims and the technical document relevant to the claims with respect to a portion where a technical feature is unidentifiable in the extracted claims of the patent document, and by acquiring a text generated by the generative model 20.

The presentation unit 103 presents a graphical user interface (GUI) related to the analysis of the claims of the patent document to the display unit 16. Specifically, the presentation unit 103 presents, on the display unit 16, the result of extraction by the extraction unit 102 using the generative model 20.

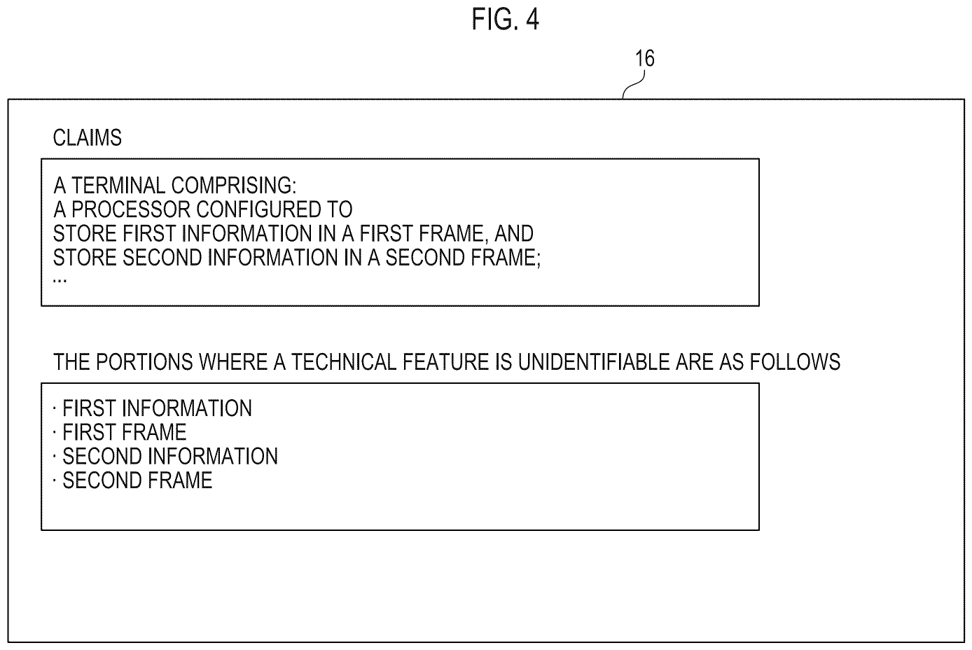

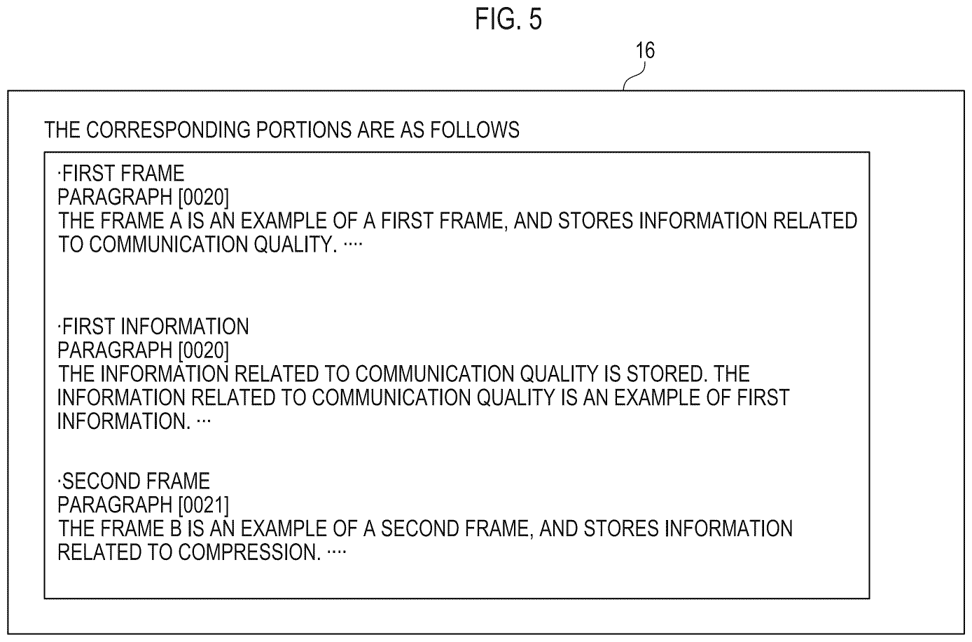

FIGS. 4 and 5 are diagrams showing examples of GUI presentation on the display unit 16 by the presentation unit 103. FIG. 4 shows an example in which the presentation unit 103 presents, on the display unit 16, the result obtained by using the generative model 20 to extract a portion where the technical feature is unidentifiable in the claims of a patent document. In FIG. 4, an example is shown in which the generative model 20 has extracted the “first frame”, the “second frame”, the “first information”, and the “second information” as portions where the technical feature is unidentifiable.

FIG. 5 shows an example in which the presentation unit 103 presents, on the display unit 16, the result obtained by using the generative model 20 to extract the correspondence relationship between the claims and the technical document relevant to the claims with respect to the portion where the technical feature is unidentifiable in the claims of the patent document. In FIG. 5, an example is shown in which the generative model 20 has extracted which portions of the technical document relevant to the claims correspond to the “first frame”, the “second frame”, and the “first information”.

With such a configuration, the information processing device 10 can cause the generative model 20 to extract a correspondence relationship between the claims and a technical document relevant to the claims, even when the claims include portions where a technical feature is unidentifiable due to reasons such as the description of each claim of the claims being abstract. With such a configuration, the information processing device 10 can reduce errors in the understanding of the claims by the generative model 20, compared to when a portion where a technical feature is unidentifiable in the claims of the patent document is not extracted.

Next, the operation of the information processing device 10 will be described.

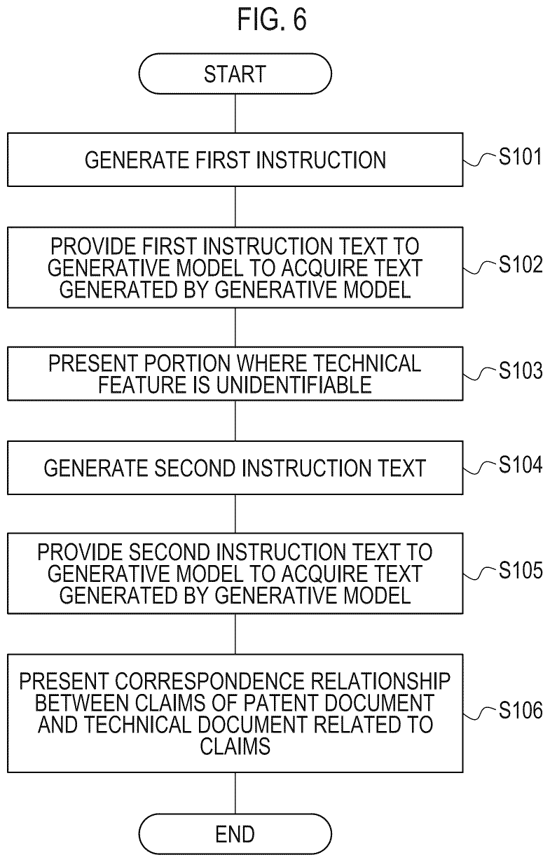

FIG. 6 is a flowchart showing a flow of information processing by the

information processing device 10. The information processing is performed when the CPU 11 reads an information processing program from the ROM 12 or the storage 14, loads the information processing program into the RAM 13, and executes the information processing program.

The CPU 11, in S101, generates an instruction text (first instruction text) for instructing the generative model 20 to extract a portion where the technical feature is unidentifiable in the claims of the patent document. For example, the CPU 11 generates an instruction text such as “Please extract a portion where the technical feature is unidentifiable in the following text in the claims”. The CPU 11 may include, in the instruction text, a description of what kind of portion constitutes a portion where the technical feature is unidentifiable.

Subsequently to S101, in S102, the CPU 11 provides the claims of the patent document and the instruction text (first instruction text) generated in S101 to the generative model 20, and acquires the text generated by the generative model 20 based on the instruction text. The CPU 11 can cause the generative model 20 to extract a portion where the technical feature is unidentifiable in the claims of the patent document by providing the claims of the patent document and the instruction text generated in S101 to the generative model 20.

Subsequent to S102, in S103, the CPU 11 presents, on the display unit 16, the portion where a technical feature is unidentifiable in the claims of the patent document, the portion having been extracted by the generative model 20 in S102.

Subsequently to S103, in S104, the CPU 11 generates an instruction text (second instruction text) for instructing the generative model 20 to extract the correspondence relationship between the claims and the technical document relevant to the claims with respect to the portion where the technical feature is unidentifiable in the claims of the patent document, the portion having been extracted by the generative model 20. For example, the CPU 11 generates an instruction text such as, “Please read the technical document relevant to the claims and extract, from the entire text of the technical document, the configuration in the technical document corresponding to the following configuration in the claims”.

Subsequently to S104, in S105, the CPU 11 provides the technical document relevant to the claims of the patent document and the instruction text (second instruction text) generated in S104 to the generative model 20, and acquires the text generated by the generative model 20 based on the instruction text. The CPU 11 can extract a correspondence relationship between the claims and a technical document relevant to the claims by providing the generative model 20 with the technical document relevant to the claims of the patent document and the instruction text generated in S104.

Subsequently to S105, in S106, the CPU 11 presents, on the display unit 16, the correspondence relationship between the claims of the patent document and the technical document relevant to the claims, the correspondence relationship having been extracted by the generative model 20 in S105.

The information processing device 10, by executing such processing, can cause the generative model 20 to extract a correspondence relationship between the claims and a technical document relevant to the claims, even when the claims include portions where a technical feature is unidentifiable due to reasons such as the description of each claim of the claims being abstract. By executing such processing, the information processing device 10 can reduce errors in the understanding of the claims by the generative model 20, compared to when a portion where a technical feature is unidentifiable in the claims of the patent document is not extracted.

Although the embodiment of the present disclosure has been described in detail with reference to the accompanying drawings, the technical scope of the present disclosure is not limited to the examples. The embodiment described above is exemplary and does not limit the technical scope of the present disclosure. It is apparent that those of ordinary skill in the art to which the present disclosure pertains can conceive of various modifications or corrections within the scope of the technical concept described in the claims, and such modifications or corrections are naturally understood to fall within the technical scope of the present disclosure.

The effects described in the embodiment are explanatory or exemplary, and are not limited to those described in the embodiment described above. In other words, the technique according to the present disclosure may achieve other effects that are apparent to those skilled in the art based on the description in the embodiment described above, together with or instead of the effects described in the embodiment described above.

Various processors other than the CPU may execute the information processing executed by the CPU reading and executing software (program) in each of the embodiments described above. Examples of the processor in this case include a programmable logic device (PLD), such as a field-programmable gate array (FPGA) that can change a circuit configuration after manufacturing, and a dedicated electric circuit that is a processor having a circuit configuration designed to execute a specific process, such as an application specific integrated circuit (ASIC). The information processing may be executed by one of the various processors, or may be executed by a combination of two or more processors of the same type or different types (for example, a plurality of FPGAs, and a combination of a CPU and an FPGA). The hardware structure of these various processors is more specifically an electrical circuit in which circuit elements, such as semiconductor elements, are combined.

In addition, in each of the embodiments described above, an aspect in which the information processing program is stored (installed) in the ROM or the storage in advance has been described, but the present disclosure is not limited thereto. The program may be provided in a form recorded on a non-transitory recording medium, such as a compact disk read only memory (CD-ROM), a digital versatile disk read only memory (DVD-ROM), or a universal serial bus (USB) memory. The program may also be in a form downloaded from an external device via a network. In addition, the present disclosure may be applied to a program product.

What is claimed is:

1. An information processing device comprising:
a generation unit configured to generate an instruction text for instructing a generative model; and
a presentation unit configured to present an output from the generative model, wherein:
the generation unit is configured to
generate a first instruction text for instructing the generative model to extract a portion where a technical feature is unidentifiable in a text related to a scope of a patent right, and
generate a second instruction text for instructing the generative model to extract a correspondence relationship between the text related to the scope of the patent right and a technical document relevant to the text related to the scope of the patent right, with respect to the portion extracted by the generative model based on the first instruction text; and
the presentation unit is configured to present the correspondence relationship extracted by the generative model based on the second instruction text.

2. The information processing device according to claim 1, wherein the technical document is a specification of an application in which the text related to the scope of the patent right is described or a standard document relevant to the text related to the scope of the patent right.

3. The information processing device according to claim 1, wherein the text related to the scope of the patent right is a text in a claim section of a patent document.

4. An information processing method comprising executing by a processor:
generating a first instruction text for instructing a generative model to extract a portion where a technical feature is unidentifiable in a text related to a scope of a patent right;
generating a second instruction text for instructing the generative model to extract a correspondence relationship between the text related to the scope of the patent right and a technical document relevant to the text related to the scope of the patent right, with respect to the portion extracted by the generative model based on the first instruction text; and
presenting the correspondence relationship extracted by the generative model, based on the second instruction text.

5. A non-transitory storage medium storing an information processing program that causes a computer to execute:
generating a first instruction text for instructing a generative model to extract a portion where a technical feature is unidentifiable in a text related to a scope of a patent right;
generating a second instruction text for instructing the generative model to extract a correspondence relationship between the text related to the scope of the patent right and a technical document relevant to the text related to the scope of the patent right, with respect to the portion extracted by the generative model based on the first instruction text; and
presenting the correspondence relationship extracted by the generative model, based on the second instruction text.
